(19) United States
(12) Patent Application Publication
(10) Pub. No.: US 2009/0225889 A1
(43) Pub. Date: Sep. 10, 2009

(54) NOVEL PARTIAL CHANNEL PRECODING AND SUCCESSIVE INTERFERENCE CANCELLATION FOR MULTI-INPUT MULTI-OUTPUT ORTHOGONAL FREQUENCY DIVISION MODULATION (MIMO-OFDM) SYSTEMS

(75) Inventors: KunJu Tsai, Forest Hills, NY (US); I-Tai Lu, Dix Hills, NY (US); Chang-Soo Koo, Melville, NY (US); Robert L. Olesen, Huntington, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/399,282

(22) Filed: Mar. 6, 2009

Related U.S. Application Data
(60) Provisional application No. 61/034,915, filed on Mar. 7, 2008.

(51) Int. Cl. H04B 7/02

(52) U.S. Cl. 375/267

(57) ABSTRACT

Methods and apparatus are disclosed for improving the frame error rate performance of a multi-input multi-output orthogonal frequency division modulation (MIMO-OFDM) system with a limited-bandwidth feedback channel is disclosed. Successive interference cancellation (SIC) is used to improve MIMO-OFDM system performance gain with cyclic redundancy check (CRC) and convolutional codes (CC). Additional performance gains are obtained when MIMO channel state information (CSI) is available at the transmitting unit.

### CROSS REFERENCE TO RELATED APPLICATION(S)

This application claims the benefit of U.S. Provisional Patent Application No. 61/034,915, filed on Mar. 7, 2008, which is incorporated by reference as if fully set forth.

### FIELD OF INVENTION

This application is related to wireless communications.

### BACKGROUND

Orthogonal frequency division modulation (OFDM) techniques have the important merit of high spectral efficiency because the adjacent OFDM sub-carriers may partially share the same spectrum while remaining orthogonal to one another. Because of this, OFDM technology has been adopted in Wireless Local Area Network (WLAN) standards such as Institute of Electrical and Electronics Engineers (IEEE) 802.11n and cellular communications such as Third Generation Partnership Project (3GPP) Long Term Evolution (LTE).

Multi-input Multi-output (MIMO) transceiver structures have the important merit of high throughput because MIMO provides multiple orthogonal eigen-channels which facilitate the transmission of multiple spatial streams from the transmitting unit to the receiving unit. However, due to the error of channel estimation, the eigen-channels cannot be fully decoupled at the receiving unit while the spatial streams become coupled, resulting in inter-spatial stream-interference (ISSI). As channel estimation error increases, ISSI and, consequently, the frame rate error (FER), increase.

Successive interference cancellation (SIC) is a power technique to improve the system performance. For example, the Vertical Bell Labs layered space-time (V-BLAST) architecture was proposed as a low-complexity detection scheme. Joint decoding schemes for cyclic redundancy check (CRC) and convolution codes (CC) have previously been studied.

Additional performance gain may be obtained when the MIMO channel state information (CSI) is available at the transmitting unit. Precoding has been proposed based on knowledge of the full channel state information at the transmitting unit, first order statistics, or second order statistics of the channel. Precoding MIMO transmission with reduced feedback has been recently proposed based on quantized CSI feedback.

### SUMMARY

Example embodiments of the application include methods and apparatus for improving reception of a multi-input multi-output orthogonal frequency division modulation (MIMO-OFDM) signal, where the MIMO-OFDM signal includes a first cyclic redundancy check (CRC) encoded bit stream and a second CRC encoded bit stream.

### BRIEF DESCRIPTION OF THE DRAWING(S)

The patent or patent application file contains at least one drawing executed in color. Copies of this patent or patent application publication with color drawing(s) will be provided by the Patent and Trademark Office upon request and payment of necessary fee.

A more detailed understanding may be had from the following description, given by way of example in conjunction with the accompanying drawings wherein:

FIG. 1 is a block diagram illustrating an example signal transmitting section of a wireless transmitter/receiver unit (WTRU) or a base station of a four channel multi-input multi-output orthogonal frequency division modulation (MIMO-OFDM) system according to the current application;

FIG. 2 is a block diagram illustrating an example signal receiving section of a WTRU or a base station, which incorporates successive interference cancellation (SIC), in a four channel MIMO-OFDM system according to the current application;

FIGS. 3 (a)-(c) are a series of graphs illustrating the signal to interference noise ratio (SINR) distributions of four spatial streams before and after SIC at SNR 5 dB;

FIGS. 4 (a) and (b) are a series of graphs illustrating a frame error rate comparison for different selections of precoding matrix under different channel conditions; and

FIG. 5 is a graph illustrating a frame error rate comparison of unequal-stream transmission for different selections of precoding matrix under different channel conditions;

FIG. 6 is a flowchart illustrating an example method for improving reception of a MIMO-OFDM signal incorporating successive interference cancellation according to the current application.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

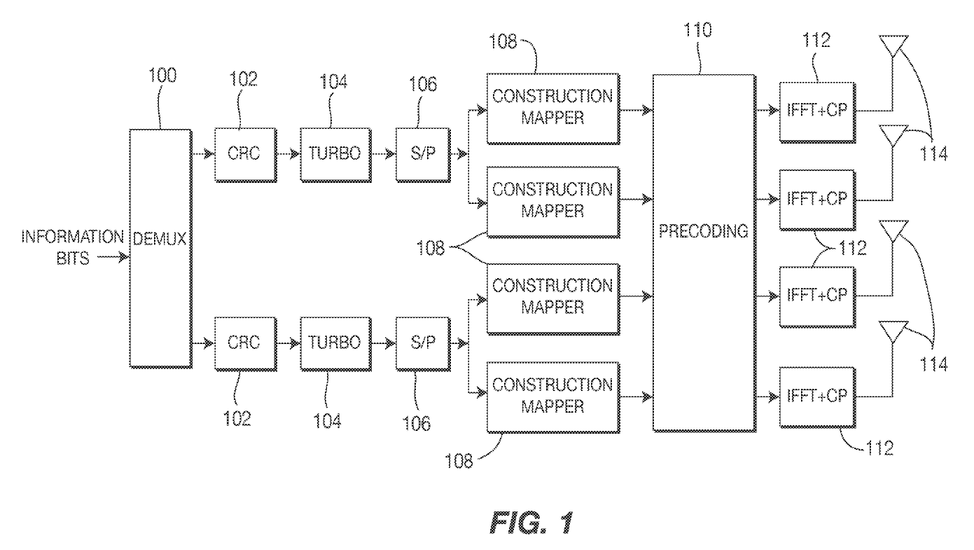

FIG. 1 shows a block diagram of an example signal transmitting section of a WTRU or a base station according to the present invention. This example signal transmitting section is configured to be used in a multi-input multi-output orthogonal frequency division modulation (MIMO-OFDM) system that uses four transmit and four receive antennas (i.e. four channels). It is noted that a four channel MIMO-OFDM system is used throughout this application; however, the specific choice of a four channel MIMO-OFDM system is for illustrative purposes and is not intended as limiting.

The information bits are de-multiplexed into two bit streams by de-multiplexer 100. Cyclic redundancy check (CRC) parity check bits, to be used for error detection at the receiving unit, are appended to each bit stream by CRC processors 102. Each of the two CRC-encoded streams is turbo encoded by one of turbo encoders 104 into a codeword and each codeword is de-multiplexed into two signal streams by stream processor 106, thereby resulting in four total signal streams. These four signal streams are constellation mapped by constellation mappers 108 and precoded into four spatial streams by pre-coding processor 110. The precoded signal streams are then modulated using an inverse fast Fourier transform (IFFT) and cyclic prefixes (CPs) are inserted by processors 112 to combat intersymbol interference (ISI) induced by multipath delay spread. Each processed signal stream is them transmitted by one of antennas 114.

To demonstrate the context of the present application, consider a block Rayleigh fading channel where the channel coefficients remain invariant during the transmission of an entire data frame. After OFDM demodulation and cyclic prefix deletion, the 4×1 received signal vector yₖ at the k^{th} sub-carrier may be represented as:

yₖ=Hₖxₖ+nₖ Equation (1)

xₖ=Fₖsₖ

where k is the sub-carrier index, Fₖ is the 4×4 unitary precoding matrix, sₖ is the 4×1 transmitted signal vector, xₖ is the 4×1 transmitted data vector, nₖ is the 4×1 noise vector and Hₖ is the 4×4 channel matrix.

The element of the i^{th} row and j^{th} column of Hₖ represents the channel gain between the j^{th} transmit and the i^{th} receive antenna. If the noises are zero mean white Gaussians, E[nₖnₖ^{H}]=σ²I where I is the identity matrix. Letting the transmit power for each transmit antenna is one, yields E[xxₖ^{H}]=I. Because E[xxₖ^{H}]=FₖE[sₖsₖ^{H}]Fₖ^{H} and Fₖ is a unitary precoding, then it is required that E[ss^{H}]=I.

For convenience, the sub-carrier index k in (1) will be omitted in the following analysis. Rewriting (1) yields:

y=Hx+n=HFs+n Equation (2)

The minimum mean square error (MMSE) estimation for the transmitted signal vector s is:

ŝ=[σ²I+(ĤF)^{H}(ĤF)]⁻¹(ĤF)^{H}y Equation (3)

where Ĥ is the estimate of channel H.

Let s=[s₁^{T} s₂^{T}]^{T} and ŝ=[ŝ₁^{T} ŝ₂^{T}]^{T} where s₁, s₂, ŝ₁ and ŝ₂ are 2×1 sub-vectors. Here, ŝᵢ is the estimate of sᵢ for i=1˜2. The resulting ŝ₁ and ŝ₂ sequences of the entire data frame are multiplexed into two estimated turbo codewords.

The two codewords are turbo decoded in order to generate two estimates of the original two bit streams. CRC test is performed to detect errors on these two estimated bit streams, the whole frame of data is accepted.

If error occurs in both estimated bit streams, the whole frame of data will be discarded. Successive interference cancellation (SIC) is performed only when error is detected in one estimated bit stream but not in the other.

Supposed error occurs in the second estimated bit stream but not in the first one, the signal components s₁ from the first bit stream may then be regenerated with almost 100% certainty and its contribution to the receive signals may be removed:

\tilde{y}=y−F₁s₁ Equation (4)

where F=[F₁ F₂]. F₁ is a 4×2 matrix consisting of the first two columns of F.

The MMSE estimation for the transmitted signal vector s₂ is:

\hat{ŝ}₂=[σ²I+(ĤF₂)^{H}(ĤF₂)]⁻¹(ĤF₂)^{H}\tilde{y} Equation (5)

where \hat{ŝ}₂ the second estimate of s₂.

The resulting \hat{ŝ}₂ sequences are multiplexed into the second codeword which is turbo decoded to obtain an estimate of the second bit stream.

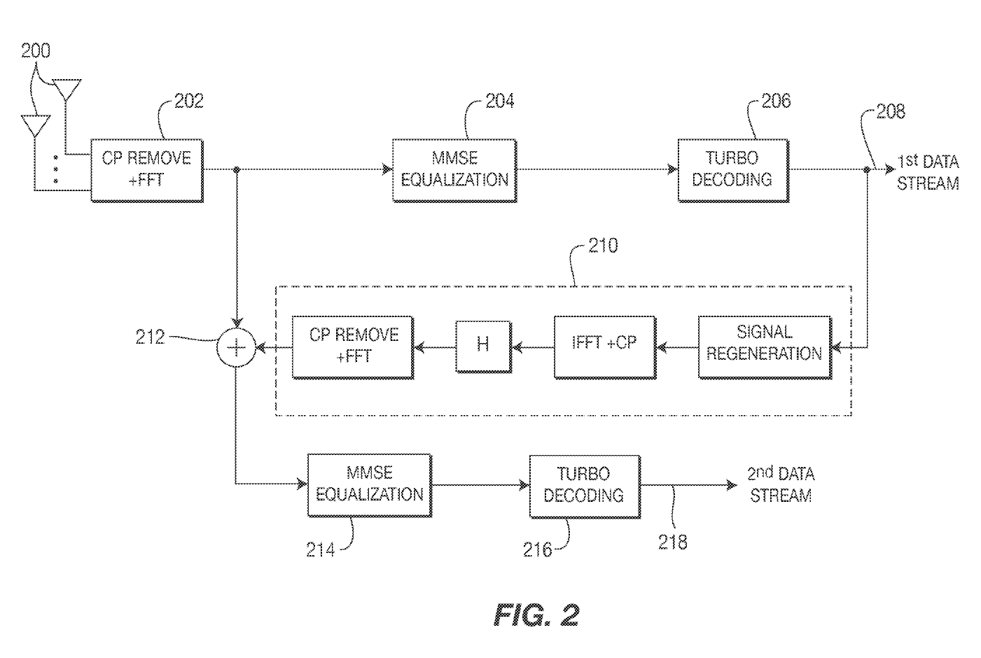

FIG. 2 shows the block diagram of an example signal receiving section of a WTRU or a base station, which incorporates SIC, in a four channel MIMO-OFDM system. In this example signal receiving section one of the bit streams may be re-estimated using SIC. CRC test is performed again on this second estimate. If any error occurs, the whole frame of data may be discarded. Otherwise, this data frame is accepted.

In time division duplexing (TDD) systems where the MIMO channel is reciprocal, the channel state information (CSI) may be obtained by reverse transmitting the training sequence from the intended receiving unit (a WTRU or base station, for example) to the intended receiving unit. Unlike TDD systems, reciprocity does not exist in frequency division duplexing (FDD) systems.

For the transmitting unit to obtain the CSI in FDD systems, the receiving unit sends forward CSI back to the transmitting unit. However, if both the transmitting unit and the receiving unit store the same CSI codebook, then only the index of the selected CSI codeword, rather than the CSI itself, may be sent back to the transmitting unit from the receiving unit through a low-rate feedback channel.

For example, let Cᵢ denote the i^{th} CSI codeword and T={Cᵢ}ᵢ₌₁^{N} denote the CSI codebook which contains N CSI codewords. At the receiving unit, two selection criteria for the CSI codeword may be considered:

a. Perform single value decomposition (SVD) on Ĥ to obtain:

Ĥ=UΣV^{H}.

From which the precoding matrix F may be chosen as follows:

$$F = arg {min}_{{C}_{i} ∈ T} {‖ V - {C}_{i} ‖}^{2} \qquad Equation ( 6 )$$

where ∥∥² denotes the square of the Frobenius norm.
or

b. Use a partial channel selection criterion, rewrite the estimated 4×4 MIMO channel matrix as follows:

$$\hat{H} = [ \begin{matrix}{\hat{H}}_{1} \\ {\hat{H}}_{2}\end{matrix} ]$$

where Ĥ₁ and Ĥ₂ are 2×4 sub-matrices. Without loss of generality, SVD may then be performed on Ĥ₁,

$${\hat{H}}_{1} = {U}_{1} {Σ}_{1} {V}_{1}^{H}$$

$$where$$

$${Σ}_{1} = [ \begin{matrix}{λ}_{11} & 0 & 0 & 0 \\ 0 & {λ}_{12} & 0 & 0\end{matrix} ] .$$

And the precoding matrix F may then be chosen as follows:

$$F = arg {min}_{{C}_{i} ∈ T} {‖ {V}_{1} ( \text{:} , 3 \text{:} 4 ) - {C}_{i} ( 3 \text{:} 4 ) ‖}^{2} \qquad Equation ( 7 )$$

where V₁(:,3:4) indicates the third and fourth columns of V₁.

It is noted that the corresponding eigenvalues of V₁(:,3:4) are zeros. Thus, if channel estimation is perfect and the feedback channel has infinite bandwidth, V₁(:,3:4)=Cᵢ(3:4). Under such a situation, the second signal stream is not be received by the first two received antennas. However, because practical channel estimation is not perfect and the feedback channel may have a very limited bandwidth, the second signal stream may likely still be partially received by the first two received antennas.

FIG. 2 shows the block diagram of an example signal receiving section of a WTRU or a base station, which incorporates SIC, in a four channel MIMO-OFDM system. This example receiving unit is configured to improve reception of the MIMO-OFDM signal, which includes a first cyclic redundancy check (CRC) encoded bit stream and a second CRC encoded bit stream. The example receiving unit includes: a receiver to receive the MIMO-OFDM signal; MMSE estimation processor 204 coupled to the receiver; first turbo decoder 206 coupled to MMSE estimation processor 204; a successive interference cancellation (SIC) processor coupled to first turbo decoder 206; and second turbo decoder 216 coupled to the SIC processor.

The receiver includes antennas 200 and receiver processor 202, which includes a CP processor and a fast Fourier transform (FFT) processor to receive the MIMO-OFDM signal.

Each antenna 200 is configured to receive a portion of the MIMO-OFDM signal. In an example four channel MIMO-OFDM system there are four antennas 200. Two of these antennas are configured to receive portions of the MIMO-OFDM signal corresponding to a first CRC encoded bit stream, and the other two antennas are configured to receive portions of the MIMO-OFDM signal corresponding to a second CRC encoded bit stream.

The CP processor is coupled to the antennas and removes a CP from each received portion of the MIMO-OFDM signal. The FFT processor is coupled to the CP processor to perform an FFT on each received portion of the MIMO-OFDM signal.

MMSE estimation processor 204 is coupled to the FFT processor of the receiver to estimate the first CRC encoded bit stream and a first partial precoding codeword from the received MIMO-OFDM signal. MMSE estimation processor 204 also makes an initial estimate of the second CRC encoded bit stream and a second partial precoding codeword from the received MIMO-OFDM signal. It is noted that the first CRC encoded bit stream, as used herein, refers to the bit stream found to have the largest signal to interference noise ratio (SINR) after initial MMSE estimation. This is often the bit stream for which the eigenvalues associated with the corresponding partial precoding codeword are larger. It is also noted that SIC processing of the second bit stream may be omitted if the second bit stream is found to have sufficient SINR after initial MMSE estimation.

MMSE estimation processor 204 may include a de-multiplexer coupled to the receiver and a bit stream processor coupled to the de-multiplexer. The de-multiplexer de-multiplexes the received MIMO-OFDM signal and generates a first received signal corresponding to the first CRC encoded bit stream and a second received signal corresponding to the second CRC encoded bit stream. The bit stream processor then estimates the first CRC encoded bit stream and the first partial precoding codeword using the first received signal. As noted above, the bit stream processor may also estimate the second CRC encoded bit stream and the second partial precoding codeword using the second received signal.

First turbo decoder 206 then de-modulates the estimated first CRC encoded bit stream using the estimated first partial precoding codeword to estimate the first set of channels 208 corresponding to the first CRC encoded bit stream. If the second bit stream is found to have sufficient SINR after initial MMSE estimation, then first turbo decoder 206 may also de-modulates the estimated second CRC encoded bit stream using the estimated second partial precoding codeword to estimate the second set of channels 218 corresponding to the second CRC encoded bit stream.

The successive interference cancellation (SIC) processor may be used to estimate the second CRC encoded bit stream and the second partial precoding codeword from the received MIMO-OFDM signal when the second bit stream is found to have insufficient SINR after initial MMSE estimation. The SIC processor uses the estimated first CRC encoded bit stream and the estimated first partial precoding codeword in this process.

An example SIC processor may include: an interference cancelling processor coupled to the first turbo decoder and second MMSE estimation processor 218 coupled to the interference cancelling processor. Alternatively the interference cancelling processor may be coupled to MMSE estimation processor 204.

The interference cancelling processor may include: signal regeneration processor 210 and signal subtracting processor 212. Signal regeneration processor 210 regenerates a first received signal corresponding to the first CRC encoded bit stream using the estimated first CRC encoded bit stream and the estimated first partial precoding codeword. The various sub-processors shown in FIG. 2 indicate processing elements involved with this signal regeneration. Signal subtracting processor 212 removes the regenerated first received signal from the received MIMO-OFDM signal to produce an interference cancelled MIMO-OFDM signal. MMSE estimation is then performed on the interference cancelled MIMO-OFDM signal by second MMSE estimation processor 214 (or alternatively MMSE estimation processor 204) to estimate the second CRC encoded bit stream and the second partial precoding codeword.

Second turbo decoder 216 de-modulates then the estimated second CRC encoded bit stream using the estimated second partial precoding codeword to estimate the second set of channels 218 corresponding to the second CRC encoded bit stream. One of ordinary skill in the art will appreciate that first turbo decoder 206 and second turbo decoder 216 may actually be the same element. These two turbo decoders are shown as separate elements in the example receiving unit of FIG. 2 to illustrate the separate processing paths that may be used to de-multiplex and decode first set of channels 208 and second set of channels 218.

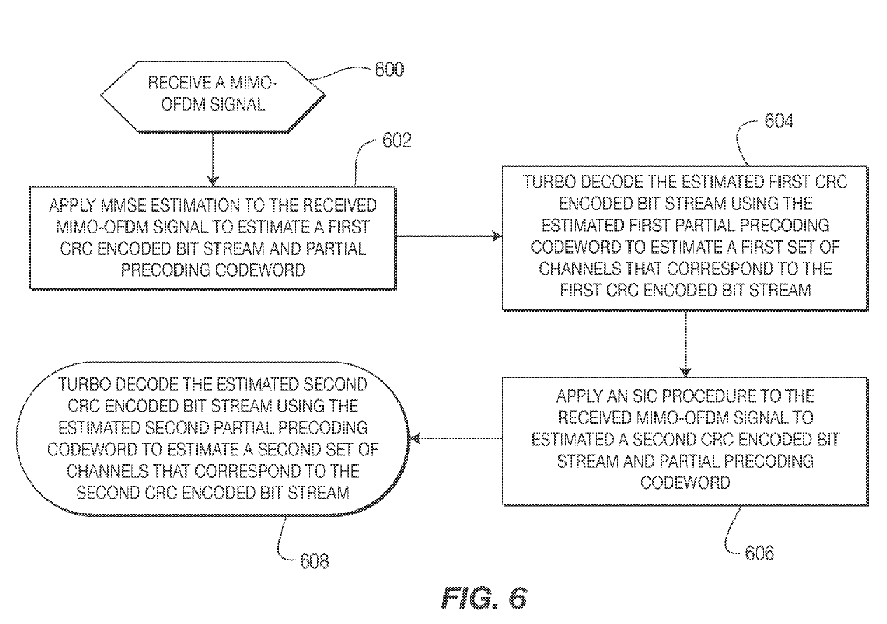

FIG. 6 illustrates an example method for improving reception of a multi-input multi-output orthogonal frequency division modulation (MIMO-OFDM) signal, where the MIMO-OFDM signal includes a first cyclic redundancy check (CRC) encoded bit stream and a second CRC encoded bit stream. This method may be performed using a receiving unit such as the example receiving unit of FIG. 2.

In the example method of FIG. 6, the MIMO-OFDM signal is received, step 600. This reception may include receiving portions of the MIMO-OFDM signal at each of a number of antennas. The cyclic prefix may then be removed from each received portion of the MIMO-OFDM signal, and each received portion of the MIMO-OFDM signal may be de-modulated using an FFT.

MMSE estimation is applied to the received MIMO-OFDM signal to estimate the first CRC encoded bit stream and the first partial precoding codeword, step 602. The MMSE estimation may involve de-multiplexing the received MIMO-OFDM signal to generate a first received signal corresponding to the first CRC encoded bit stream and a second received signal corresponding to the second CRC encoded bit stream. The first CRC encoded bit stream and the first partial precoding codeword may be estimate using the first received signal. The second CRC encoded bit stream and the second partial precoding codeword may also be estimated using the second received signal.

The estimated first CRC encoded bit stream may be turbo decoded, step 604, using the estimated first partial precoding codeword, to estimate a first set of channels, which correspond to the first CRC encoded bit stream.

An SIC procedure is applied to the received MIMO-OFDM signal, step 606, to estimated the second CRC encoded bit stream and the second partial precoding codeword. The SIC procedure uses the estimated first CRC encoded bit stream and the estimated first partial precoding codeword to accomplish estimates. The SIC procedure may include regenerating a first received signal corresponding to the first CRC encoded bit stream using the estimated first CRC encoded bit stream and the estimated first partial precoding codeword. The regenerated first received signal is removed from the received MIMO-OFDM signal to produce an interference cancelled MIMO-OFDM signal. MMSE estimation is then applied to the interference cancelled MIMO-OFDM signal to estimate the second CRC encoded bit stream and the second partial precoding codeword.

The estimated second CRC encoded bit stream is turbo decoded, step 608, using the estimated second partial precoding codeword to estimate the second set of channels corresponding to the second CRC encoded bit stream.

Simulation Results

In these simulations, there are 128 subcarriers in each OFDM symbol and only 96 out of the 128 subcarriers are used for transmission. Each data frame consists of 11 OFDM symbols. The first four symbols in each frame are training symbols used for channel estimation and the remaining seven symbols are used for the data transmission. Turbo encoder with rate 1/3 is applied. For the CRC test, the generator polynomial g₂₄(x) is x²⁴+x²³+x⁶+x⁵+x+1, which is used in LTE systems. The codebook used for simulation is also specified in LTE systems. In the CSI codebook, the total number of CSI codewords N is 16. Spatially uncorrelated MIMO channel models with two, six and twenty delay taps are used in the simulation. For the two-tap channel, each tap has equal power; for the six-tap and twenty-tap channels, the channel has exponential delay profile. In the following numerical results, 1000 frames are simulated for each case and the least square (LS) approach is employed for channel estimation

A. Analysis of Post-Equalized SINR

After MMSE equalization in (2), the SINR of i^{th} spatial stream may be express as:

$${SINR}_{i} = \frac{1}{{[ ( I + {F}^{H} {\hat{H}}^{H} \hat{H} F ) ]}_{i , i}^{- 1}} - 1 , \\ i = 1 , 2 , 3 , 4 \qquad Equation ( 8 )$$

where [A]_{i,i} indicates the i^{th} diagonal element of matrix A.

SIC is employed to enhance the SINR's of two out of the four spatial streams. The improved SINR's may be expressed as:

$${\overline{SINR}}_{j} = \frac{1}{{[ ( I + {F}_{i}^{H} {\hat{H}}^{H} \hat{H} {F}_{i} ) ]}_{l , l}^{- 1}} - 1 , \\ l = 1 , 2 , \{ \begin{matrix}j = l + 2 & if i = 2 \\ j = l & if i = 1\end{matrix} \qquad Equation ( 9 )$$

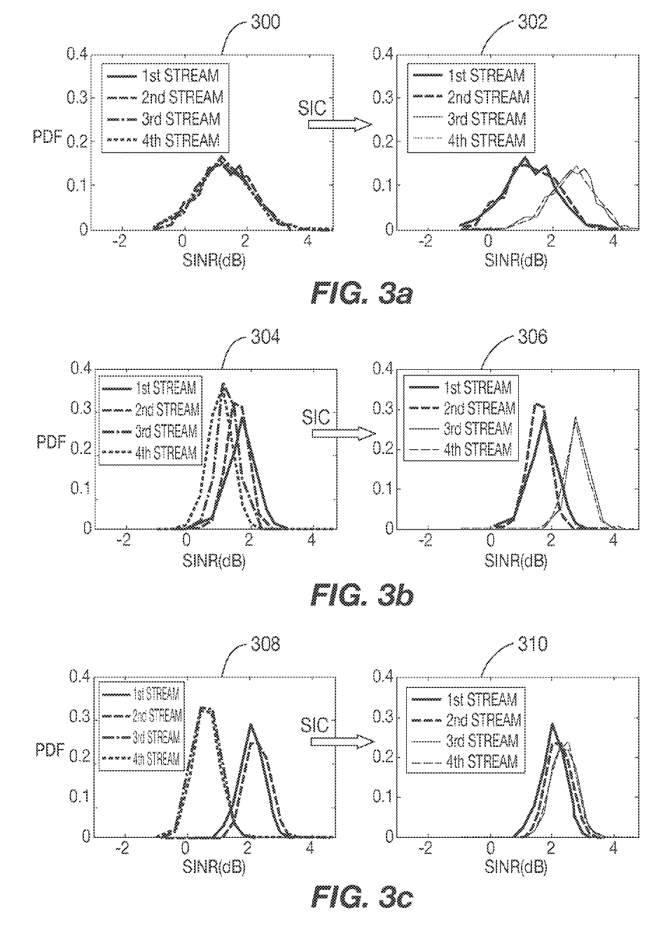

FIGS. 3 (a)-(c) show SINR distributions of the four spatial streams for three different selections of precoding matrix at SNR=5 dB. The four SINR distributions before SIC are shown in the left side in FIGS. 3 (a)-(c) and the four SINR distributions after SIC are shown in the right side of FIGS. 3 (a)-(c).

Without precoding (i.e., the precoding matrix is the identity matrix), the four spatial streams have similar SINR distributions before SIC (see graph 300 in FIG. 3 (a)). However, after SIC, the mean SINR's of the two SIC-improved spatial streams are around 2 dB higher than the mean SINR's of the two unimproved spatial streams (see graph 302 in FIG. 3 (a)).

For the conventional SVD precoding scheme, before SIC, the spatial streams corresponding to larger eigenvalues have better SINR's than those corresponding to smaller eigenvalues (see graph 304 in FIG. 3 (b)). Therefore, SIC is performed to improve the SINR's of the two spatial streams corresponding to the two smallest eigenvalues.

After SIC, the mean SINR's of these two weak streams improved greatly (around 2 dB). Now, as shown in graph 306 in FIG. 3 (b), they become 1.5 dB stronger than the two spatial streams corresponding to the two largest eigenvalues.

For the proposed partial channel precoding scheme, without loss of generality, we will perform SVD of H₁ and use (7) to choose the precoding matrix for explaining numerical results shown in graphs 308 and 310 in FIG. 3 (c).

Before SIC (graph 308), the mean SINR's of the first and second streams are higher than those derived from the conventional SVD precoding scheme; however, the mean SINR's of the third and fourth streams are lower than those derived from the conventional SVD precoding scheme.

After SIC (graph 310), the mean SINR's of these two weak streams improved greatly (around 2 dB). Now, the four spatial streams have similar SINR distributions

B. Performance Evaluation

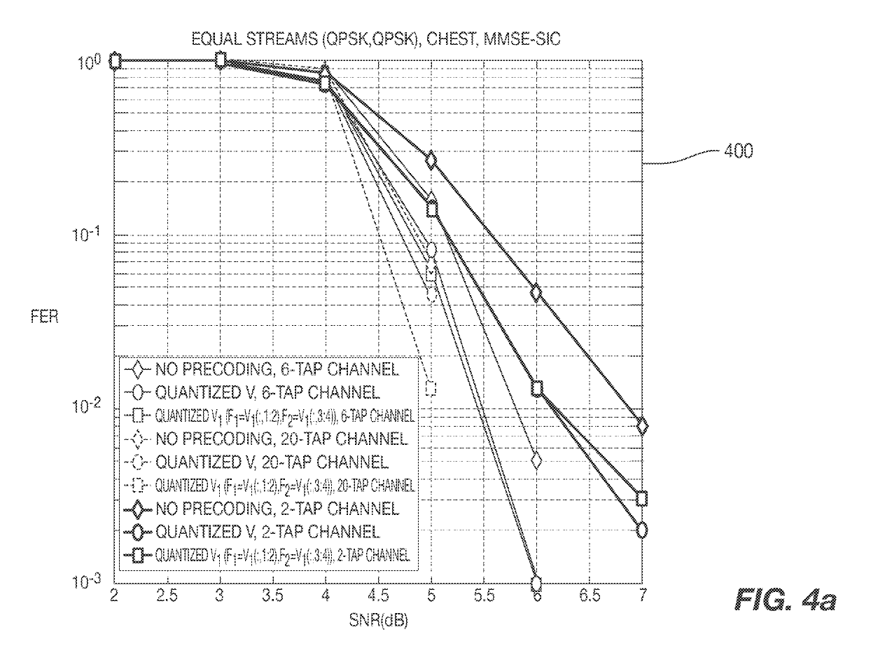

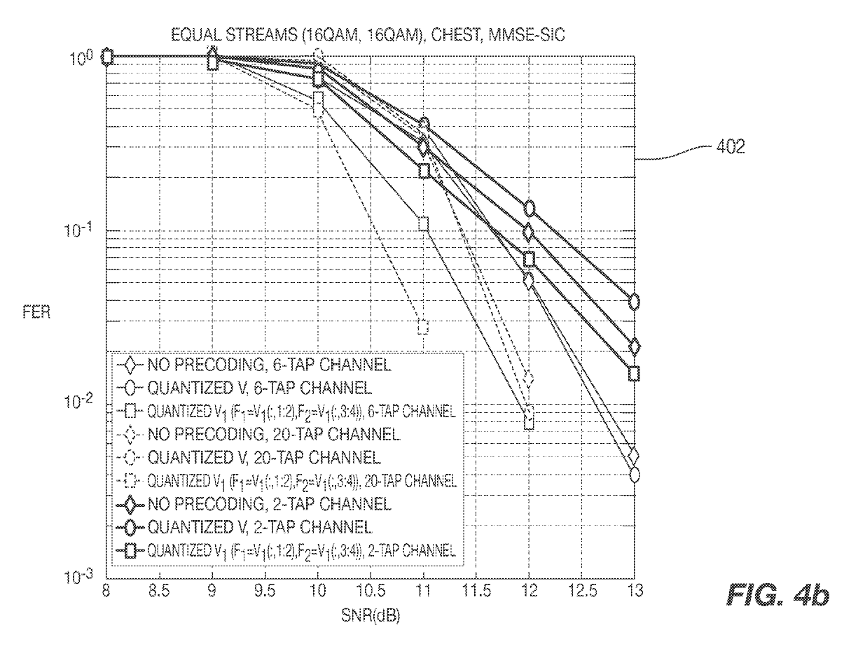

FIG. 4 shows the frame error rate (FER) of equal-stream transmission for different selections of precoding matrix and three different channel conditions. Two different constellation schemes, (QPSK, QPSK, shown in graph 400 in FIG. 4 (a)) and (16QAM, 16QAM, shown in graph 402 in FIG. 4 (b)), are presented.

For the same precoding scheme, if the MIMO channel is more frequency-selective (i.e., more channel taps), the better FER will be obtained. Generally speaking, the proposed partial channel precoding has the best FER performance and the no-precoding case has the worst FER performance for all channel conditions and all modulation schemes.

For example, consider the case of a highly frequency-selective channel (20 taps) and a high constellation modulation scheme (16QAM). Compared to the no-precoding case, at FER=10%, 0.8 dB gain is obtained using the proposed precoding approach and only 0.2 dB is obtained using the conventional SVD precoding.

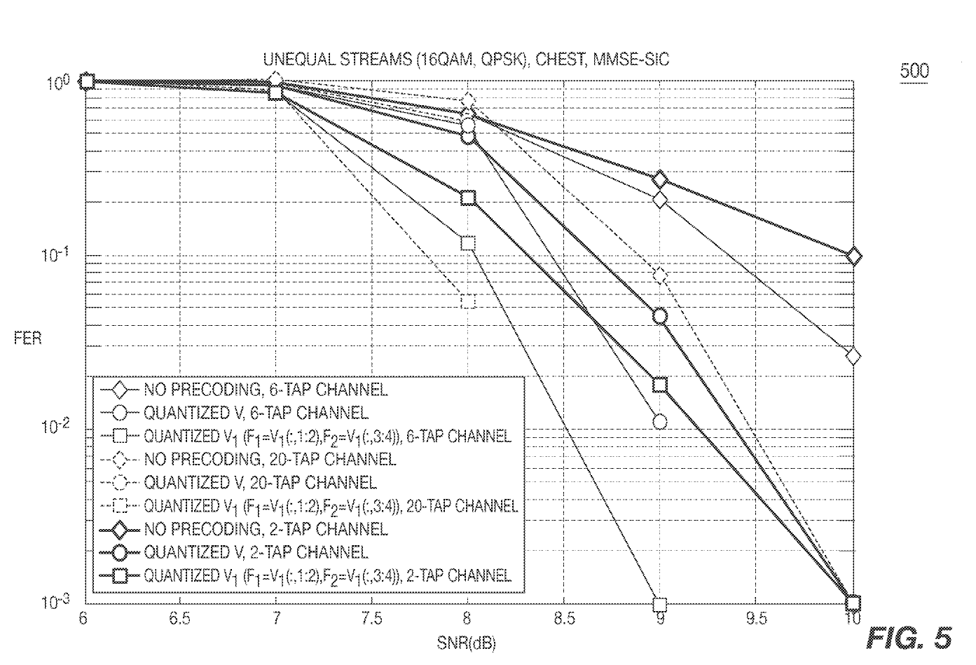

The FER of unequal-stream transmission (16QAM,QPSK) over different channels is shown in graph 500 of FIG. 5. The conclusions are similar to those in FIGS. 4 (a) and (b). For the same precoding scheme, if the MIMO channel is more frequency-selective (i.e., more channel taps), the better FER will be obtained. Again, the proposed partial channel precoding has the best FER performance and the no-precoding case has the worst FER performance for all channel conditions

Compared to the no-precoding case, at FER=10%, 1.3 dB gain is obtained using the proposed precoding approach and only 0.5 dB is obtained using the conventional SVD precoding.

Although the features and elements are described in particular combinations, each feature or element may be used alone without the other features and elements or in various combinations with or without other features and elements. The methods provided may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors may include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. The various processor described herein may be embodied in separate elements. Alternatively, it is contemplated that two or more of these example processors may coexist within a single processor element.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method for improving reception of a multi-input multi-output orthogonal frequency division modulation (MIMO-OFDM) signal, where the MIMO-OFDM signal includes a first cyclic redundancy check (CRC) encoded bit stream and a second CRC encoded bit stream, the method comprising:
receiving the MIMO-OFDM signal;
applying minimum mean square error (MMSE) estimation to the received MIMO-OFDM signal to estimate the first CRC encoded bit stream and a first partial precoding codeword;
turbo decoding the estimated first CRC encoded bit stream using the estimated first partial precoding codeword to estimate a first set of channels corresponding to the first CRC encoded bit stream;
applying a successive interference cancellation (SIC) procedure to the received MIMO-OFDM signal to estimate the second CRC encoded bit stream and a second partial precoding codeword, where the SIC procedure uses the estimated first CRC encoded bit stream and the estimated first partial precoding codeword; and
turbo decoding the estimated second CRC encoded bit stream using the estimated second partial precoding codeword to estimate a second set of channels corresponding to the second CRC encoded bit stream.

2. A method according to claim 1, wherein receiving the MIMO-OFDM signal includes:
receiving a portion of the MIMO-OFDM signal at each of a plurality of antennas;
removing a cyclic prefix from each received portion of the MIMO-OFDM signal; and
fast Fourier transforming each received portion of the MIMO-OFDM signal.

3. A method according to claim 1, wherein applying MMSE estimation to the received MIMO-OFDM signal includes:
de-multiplexing the received MIMO-OFDM signal to generate a first received signal corresponding to the first CRC encoded bit stream and a second received signal corresponding to the second CRC encoded bit stream; and
estimating the first CRC encoded bit stream and the first partial precoding codeword using the first received signal.

4. A method according to claim 3, wherein applying MMSE estimation to the received MIMO-OFDM signal further includes:
estimating the second CRC encoded bit stream and a second partial precoding codeword using the second received signal.

5. A method according to claim 3, wherein a signal to interference noise ratio (SINR) of the estimated first CRC encoded bit stream is larger than a SINR of the estimated second CRC encoded bit stream.

6. A method according to claim 1, wherein eigenvalues associated with the first partial precoding codeword are larger than eigenvalues associated with the second partial precoding codeword.

7. A method according to claim 1, wherein applying the SIC procedure to the MIMO-OFDM signal includes:
regenerating a first received signal corresponding to the first CRC encoded bit stream using the estimated first CRC encoded bit stream and the estimated first partial precoding codeword;
removing the regenerated first received signal from the received MIMO-OFDM signal to produce an interference cancelled MIMO-OFDM signal; and
applying MMSE estimation to the interference cancelled MIMO-OFDM signal to estimate the second CRC encoded bit stream and a second partial precoding codeword.

8. A wireless transmitter/receiver unit (WTRU) configured to improve reception of a multi-input multi-output orthogonal frequency division modulation (MIMO-OFDM) signal, where the MIMO-OFDM signal includes a first cyclic redundancy check (CRC) encoded bit stream and a second CRC encoded bit stream, the WTRU comprising:
a receiver to receive the MIMO-OFDM signal;
a minimum mean square error (MMSE) estimation processor coupled to the receiver to estimate the first CRC encoded bit stream and a first partial precoding codeword from the received MIMO-OFDM signal;
a first turbo decoder coupled to the MMSE estimation processor to de-modulate the estimated first CRC encoded bit stream using the estimated first partial precoding codeword to estimate a first set of channels corresponding to the first CRC encoded bit stream;
a successive interference cancellation (SIC) processor coupled to the first turbo decoder to estimate the second CRC encoded bit stream and a second partial precoding codeword from the received MIMO-OFDM signal, where the SIC processor uses the estimated first CRC encoded bit stream and the estimated first partial precoding codeword; and
a second turbo decoder coupled to the SIC processor to de-modulate the estimated second CRC encoded bit stream using the estimated second partial precoding codeword to estimate a second set of channels corresponding to the second CRC encoded bit stream.

9. A WTRU according to claim 8, wherein the receiver includes:
a plurality of antennas, each antenna configured to receive a portion of the MIMO-OFDM signal;
a cyclic prefix (CP) processor coupled to the plurality of antennas to remove a CP from each received portion of the MIMO-OFDM signal; and
a fast Fourier transform (FFT) processor coupled to the CP processor to FFT each received portion of the MIMO-OFDM signal.

10. A WTRU according to claim 8, wherein:
the plurality of antennas is four antennas;
two antennas of the four antennas are configured to receive portions of the MIMO-OFDM signal corresponding to the first CRC encoded bit stream; and
the other two of the four antennas are configured to receive portions of the MIMO-OFDM signal corresponding to the second CRC encoded bit stream.

11. A WTRU according to claim 8, wherein the MMSE estimation processor includes:
a de-multiplexer coupled to the receiver to de-multiplex the received MIMO-OFDM signal and generate:
a first received signal corresponding to the first CRC encoded bit stream; and
a second received signal corresponding to the second CRC encoded bit stream; and
a bit stream processor coupled to the de-multiplexer to estimate the first CRC encoded bit stream and the first partial precoding codeword using the first received signal.

12. A WTRU according to claim 11, wherein the bit stream processor further estimates the second CRC encoded bit stream and a second partial precoding codeword using the second received signal.

13. A WTRU according to claim 8, wherein the SIC processor includes:
an interference cancelling processor coupled to the first turbo decoder to regenerate a first received signal corresponding to the first CRC encoded bit stream using the estimated first CRC encoded bit stream and the estimated first partial precoding codeword, and to remove the regenerated first received signal from the received MIMO-OFDM signal to produce an interference cancelled MIMO-OFDM signal; and
another MMSE estimation processor coupled to the interference cancelling processor to estimate the second CRC encoded bit stream and a second partial precoding codeword from the interference cancelled MIMO-OFDM signal.

14. A WTRU according to claim 8, wherein:
the SIC processor includes an interference cancelling processor couple to the first turbo decoder to regenerate a first received signal corresponding to the first CRC encoded bit stream using the estimated first CRC encoded bit stream and the estimated first partial precoding codeword, and to remove the regenerated first received signal from the received MIMO-OFDM signal to produce an interference cancelled MIMO-OFDM signal; and
the MMSE estimation processor is further coupled to the interference cancelling processor to estimate the second CRC encoded bit stream and a second partial precoding codeword from the interference cancelled MIMO-OFDM signal.

15. A base station configured to improve reception of a multi-input multi-output orthogonal frequency division modulation (MIMO-OFDM) signal, where the MIMO-OFDM signal includes a first cyclic redundancy check (CRC) encoded bit stream and a second CRC encoded bit stream, the base station comprising:
a receiver to receive the MIMO-OFDM signal;
a minimum mean square error (MMSE) estimation processor coupled to the receiver to estimate the first CRC encoded bit stream and a first partial precoding codeword from the received MIMO-OFDM signal;
a first turbo decoder coupled to the MMSE estimation processor to de-modulate the estimated first CRC encoded bit stream using the estimated first partial precoding codeword to estimate a first set of channels corresponding to the first CRC encoded bit stream;
a successive interference cancellation (SIC) processor coupled to the first turbo decoder to estimate the second CRC encoded bit stream and a second partial precoding codeword from the received MIMO-OFDM signal, where the SIC processor uses the estimated first CRC encoded bit stream and the estimated first partial precoding codeword; and
a second turbo decoder coupled to the SIC processor to de-modulate the estimated second CRC encoded bit stream using the estimated second partial precoding codeword to estimate a second set of channels corresponding to the second CRC encoded bit stream.

16. A base station according to claim 15, wherein the receiver includes:
a plurality of antennas, each antenna configured to receive a portion of the MIMO-OFDM signal;
cyclic prefix (CP) processor coupled to the plurality of antennas to removing a CP from each received portion of the MIMO-OFDM signal; and
a fast Fourier transform (FFT) processor coupled to the CP processor the FFT each received portion of the MIMO-OFDM signal.

17. A base station according to claim 16, wherein:
the plurality of antennas is four antennas;
two antennas of the four antennas are configured to receive portions of the MIMO-OFDM signal corresponding to the first CRC encoded bit stream; and
the other two of the four antennas are configured to receive portions of the MIMO-OFDM signal corresponding to the second CRC encoded bit stream.

18. A base station according to claim 15, wherein the MMSE estimation processor includes:
a de-multiplexer coupled to the receiver to de-multiplex the received MIMO-OFDM signal and generate:
a first received signal corresponding to the first CRC encoded bit stream; and
a second received signal corresponding to the second CRC encoded bit stream; and
a bit stream processor coupled to the de-multiplexer to estimate the first CRC encoded bit stream and the first partial precoding codeword using the first received signal.

19. A base station according to claim 15, wherein the SIC processor includes:
an interference cancelling processor coupled to the first turbo decoder to regenerate a first received signal corresponding to the first CRC encoded bit stream using the estimated first CRC encoded bit stream and the estimated first partial precoding codeword and remove the regenerated first received signal from the received MIMO-OFDM signal to produce an interference cancelled MIMO-OFDM signal; and
another MMSE estimation processor coupled to the interference cancelling processor to estimate the second CRC encoded bit stream and a second partial precoding codeword from the interference cancelled MIMO-OFDM signal.

20. A base station according to claim 15, wherein:
the SIC processor includes an interference cancelling processor couple to the first turbo decoder to regenerate a first received signal corresponding to the first CRC encoded bit stream using the estimated first CRC encoded bit stream and the estimated first partial precoding codeword and remove the regenerated first received signal from the received MIMO-OFDM signal to produce an interference cancelled MIMO-OFDM signal; and
the MMSE estimation processor is further coupled to the interference cancelling processor to estimate the second CRC encoded bit stream and a second partial precoding codeword from the interference cancelled MIMO-OFDM signal.
